(19) United States
(12) Patent Application Publication
(10) Pub. No.: US 2026/0025534 A1
(43) Pub. Date: Jan. 22, 2026

(54) Scalable Server-Side Ad Insertion for Live Events

(71) Applicant: Harmonic, Inc., San Jose, CA (US)

(72) Inventors: Jean-Louis Yves Diascorn, Betton (FR); Timothy John Michael Warren, Hong Kong (HK)

(73) Assignee: Harmonic, Inc., San Jose, CA (US)

(21) Appl. No.: 19/268,805

(22) Filed: Jul. 14, 2025

Related U.S. Application Data
(60) Provisional application No. 63/672,669, filed on Jul. 17, 2024.

(51) Int. Cl. H04N 21/234; G06Q 30/0204; G06Q 30/0251

(52) U.S. Cl. CPC H04N 21/23424; G06Q 30/0204; G06Q 30/0251

(57) ABSTRACT

Server-side ad insertion (SSAI) systems for use with live broadband video streams. Users of a content delivery network (CDN) are grouped into a plurality of cohorts, which are groups of users having a matching set of user characteristics. When a video ecosystem receives a request to stream a live broadband video stream to a user, the cohort for that user is identified. Then, an advertisement to be shown to all members of that cohort viewing the live broadband video stream is identified and incorporated into the live broadband video stream at the video ecosystem to create a cohort-targeted live video stream for the user. The video ecosystem may then transmit the cohort-targeted live broadband video stream to a user device associated with the user. Content related to advertisement identification and insertion may be cached to expedite target advertisement processing for subsequent viewers in the same cohort.

### CLAIM OF PRIORITY

This application claims priority to U.S. non-provisional patent application Ser. No. 63/672,669, filed on Jul. 17, 2024, invented by Timothy John Michael Warren and Jean-Louis Yves Diascorn, entitled “Scalable Server-Side Ad Insertion for Live Events,” the entire contents of which are hereby incorporated by reference for all purposes as if fully set forth herein.

### FIELD OF THE INVENTION

Embodiments of the invention generally relate to digital advertising technologies, specifically to server-side ad insertion (SSAI) systems supporting live streaming events.

### BACKGROUND

Traditional broadcast models allow for the delivery of a single advertisement, or ad, to a vast audience, whereas digital platforms often seek to personalize the ads that are delivered to individual users. This personalization requires a one-to-one mapping of ads to viewers, which can result in a significant number of distinct efforts in delivering individual ads.

The technical environment supporting digital advertising during live broadcasts, particularly for over-the-top (OTT) media services, presents challenges, such as managing a high volume of simultaneous requests for content customization and delivering tailored content to a vast audience with minimal delay. Traditional methods, which may suffice for non-live content, struggle to scale effectively when faced with the demands of live events, where the simultaneous nature of viewership demands instantaneous advertisement insertion to maintain the live experience. Presently, bottlenecks exist that cannot be resolved simply by increasing financial investment in the supporting physical infrastructure. Moreover, the integration of content customization systems with live streaming services exacerbates these challenges. The existing systems require rapid processing of individual requests and content deliveries, which becomes increasingly difficult as the audience size—and consequently, the number of requests—grows.

### BRIEF DESCRIPTION OF THE DRAWINGS

FIG. 1 is a flowchart illustrating the steps of Dynamic Ad Insertion (DAI) using cohorts in accordance with an embodiment of the invention;

FIG. 2 is an illustration of determining cohort membership based on illustrative user characteristics in accordance with an embodiment of the invention;

FIG. 3 is an illustration of a server-side ad-insertion environment that employs cohorts in accordance with an embodiment of the invention;

FIG. 4 is an illustration of beacon URL generation and distribution in a server-side ad-insertion environment in accordance with an embodiment of the invention; and

FIG. 5 is a block diagram of a computer system in accordance with an embodiment of the invention.

### DETAILED DESCRIPTION OF THE INVENTION

In the following description, for the purposes of providing a detailed explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

### Functional Overview

The limitations of current technologies in handling large-scale, real-time live streaming events evidence a need in the art for more efficient solutions that can support a high concurrency of live event streaming without compromising on the customization and targeting of advertisements (ads). Advantageously, embodiments of the invention provide for a scalable approach for deploying Dynamic Ad Insertion (DAI) having particular utility during live events. Techniques shall be presented for grouping viewers of digital video content into ‘cohorts.’ Members of a cohort share the same set of user characteristics; such users characteristics shared by members of a cohort may be used as a basis for selecting which ads are suitable or desirable to show to a viewer. Embodiments of the invention may display each cohort member the same advertisement in a broadcast stream of a digital video. As each cohort member may be provided the same advertisement at a particular time in the same broadcast stream, the demand on the technical infrastructure supporting customization and targeting of ad content is greatly reduced.

Manifests are mechanisms that specify what advertisements are to be inserted into a broadcast stream at particular points in time. Embodiments allow for manifests to be cached, thus enabling cohort members to experience efficiencies in ad identification and retrieval due to the availability of cached content. Furthermore, embodiments provide for the multidimensional partitioning of the audience, which enables the viewership of individual customized ads delivered to cohort members in a broadcast to be tracked while maintaining the ability to deliver targeted advertising at scale.

### Cohorts

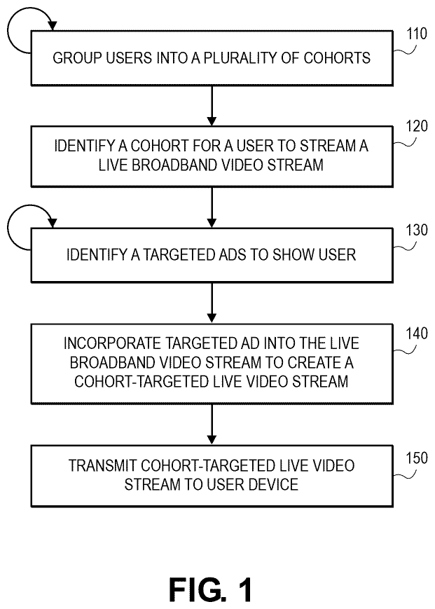

FIG. 1 is a flowchart illustrating the steps of Dynamic Ad Insertion (DAI) using cohorts in accordance with an embodiment of the invention. Initially, in step 110, users of a Content Delivery Network (CDN) are grouped into a plurality of cohorts. A cohort is a group of users which are associated with a matching set of user characteristics. Such user characteristics describe attributes or traits of a user, such as those defined by version 1.1 of the Interactive Advertising Bureau (IAB) taxonomy of user characteristics by IAB Technology Laboratory of New York, New York. Non-limiting, illustrative examples of user characteristics which may be used to define membership in a cohort include: user wealth, user demographics, the geographic location associated with a user account, the user's age, user income, one or more user interests, and user purchase intent.

For example, in an exemplary system, a user's age may be categorized into thirteen separate categories, a user's income may be categorized into eleven separate categories, and a user's interests may be tracked using twenty-nine different flags or variables that may be individually selected or not selected depending on the express or inferred interests of the user. Such interests may be wide-ranging and may follow any level of granularity, e.g., an interest may correspond to interest in a sport or interest in a particular team of a particular sport.

Rules may be established for mapping distinct combinations of user characteristics to cohorts. For example, each separate, distinct combination of the assigned age category and income category may be mapped to a separate cohort; however, in some cases, certain different selections of user characteristics may map to the same cohort, e.g., a stated interest in fishing or in the Cleveland Browns football team may be sufficient to qualify for membership in a particular cohort regardless of a user's designated income categorization.

In some embodiments, each cohort may be associated with a priority. If a user may qualify for two or more cohorts based on their user characteristics, then the user is assigned membership to the cohort having the highest priority.

The grouping of users into cohorts in step 110 may be repeated as needed, as shown in FIG. 1, as the numbers of users and defined cohorts changes over time. The particular entity that groups users into cohorts in step 110 may vary from embodiment to embodiment, e.g., the grouping of users into cohorts may be performed in a video ecosystem, outside of the video ecosystem, or partially in the video ecosystem and partially outside the video ecosystem, as shall be explained in more detail below.

An embodiment of the invention may employ machine learning techniques to analyze viewer data and dynamically group viewers into cohorts based on shared characteristics. This grouping could be informed by real-time analytics, allowing for the creation of cohorts that reflect the evolving interests and behaviors of the audience during a live event. After a cohort has been assigned to a particular user, the assignment of cohort to user may be tracked and managed using a Cohort Identifier (ID), which is a unique identifier of a cohort, which is assigned to that user. In this way, upon retrieving the Cohort ID for a user, the particular cohort for that user may ascertained.

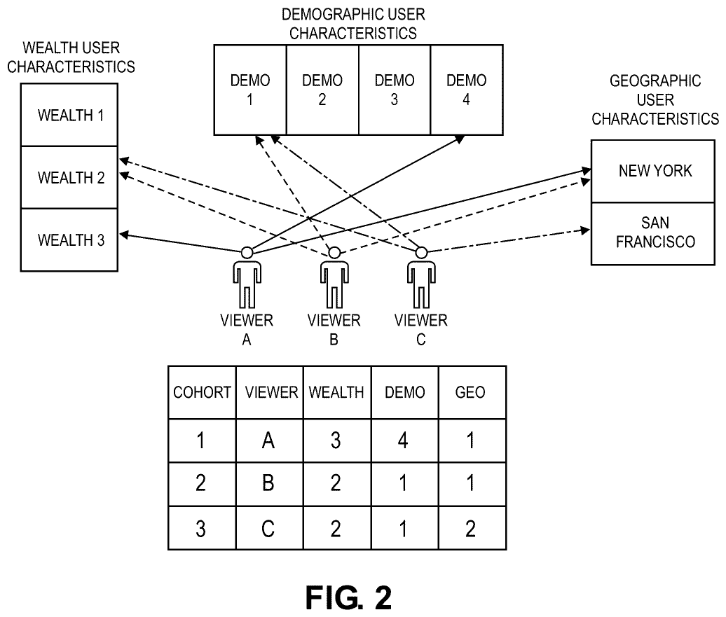

FIG. 2 is an illustration of a simplified cohort membership example based on illustrative user characteristics in accordance with an embodiment of the invention. In the example of FIG. 2, there are three users labeled viewer A, viewer B, and viewer C. There are also user characteristics in the form of three categories of user wealth, four categories for user demographics, and two categories for user geography. Each of the three wealth categories corresponds to a different level of viewer affluence, which can be a significant factor in determining the type of ads that are most relevant to the viewers within that category. Each of the four demographic categories corresponds to a different demographic segment; such demographic segments may include factors such as age, gender, education level, or any other demographic information that can influence ad selection. By segmenting viewers based on these demographics, ads may be selected for presentation that are more likely to resonate with the viewers' interests and lifestyles. Each of the two geographic categories may be used to group viewers into cohorts based on user's location, which allows for consideration of regional preferences, local brands, and cultural nuances when selecting which ads to display to users of each cohort. This geographic information ensures that the ads are not only relevant to the viewers' interests, but also to their local context, which can significantly impact the viewers' engagement with the ad content.

In an embodiment, an Ad Serving System (ADS) may use the user characteristics associated with a cohort to tailor the ad content to the financial demographics of the viewers, thereby enhancing the effectiveness of ad campaigns. Thus, the ADS may have control over cohort enrollment and ad placement decisions, although such control may be shared or reside elsewhere, as shall be explained further in the next section.

### Video Ecosystem

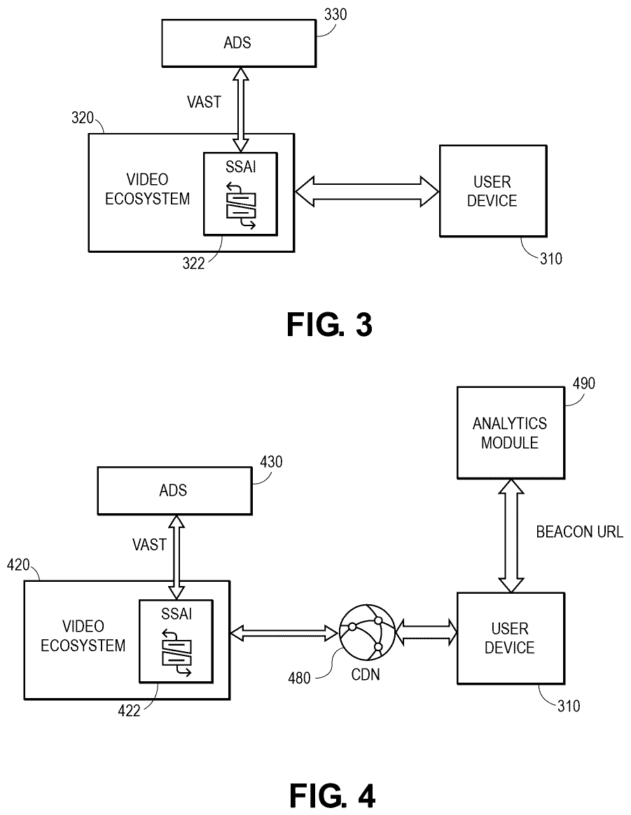

Steps 120-150 of FIG. 1 may be performed by a video ecosystem in response to the video ecosystem receiving a request to stream a live broadband video stream to a user. To provide a concrete example, the description of steps 120-150 of FIG. 1 shall refer to FIG. 3, which is an illustration of a server-side ad-insertion environment that employs cohorts in accordance with an embodiment of the invention. As shown in FIG. 3, a server-side ad insertion environment of an embodiment comprises a user device 310, a video ecosystem 320, and an Ad Decision System (ADS) 330.

A user operates user device 310 to send a request for video content to video ecosystem 320. Video ecosystem 320 processes that request, and sends the requested video content to user device 310. The requested video content sent to the user device 310 contains targeted ads that have been selected for presentation to the user of user device 310. In processing the request for video content, video ecosystem 320 may, but need not as explained below, communicate with ADS 330 to receive the targeted ads, or links to the targeted ads, that are inserted into the requested video content provided to user device 310.

User device 310, as broadly used herein, refers to any physical component capable of issuing a digital request over a network to video ecosystem 320 for video content. Non-limiting, illustrative examples of a user device include a connected TV (CTV), a personal computer, a mobile phone, a laptop computer, and a tablet computer. For example, a user (i.e., a viewer or a subscriber of a content delivery network (CDN)) might use user device 310 to issue a request to video ecosystem 320 to watch a live streaming event that is being streamed to a large number of different devices. While only one user device 310 is depicted in the example of FIG. 3, those in the art will readily appreciate that practical implementations of server-side ad insertion environment support a large number of user devices 310.

Video ecosystem 320, as broadly used herein, refers to any system responsible for receiving and processing requests for digital video content from users issued from their user devices 310. Video ecosystem 320 is tasked to support content delivery to large number of viewers in a manner that ensures a high-quality viewing experience is maintained during periods of high demand, i.e., periods in which many user devices 310 are issuing requests for video content concurrently. In processing requests for digital video content issued from user devices 310, video ecosystem 320 may communicate with ADS 330 to obtain advertisements, which video ecosystem 320 may then insert or incorporate into the digital video requested by a user device 310 prior to its delivery to that user device 310. Video ecosystem 320 includes all infrastructure necessary to stream video content to end-users, including but not limited to video players/video servers and optionally one or more content delivery networks (CDNs). As is well-known in the art, a video player or video server may generate and/or stream digital video in accordance with a number of different video codecs.

One particular component comprised within video ecosystem 320 is the server-side advertisement insertion (SSAI) module 322, which is a software component, capable of running on general-purpose hardware, that is responsible for requesting ADS 330 for ad content, receiving that requested ad content from ADS 330, and integrating that ad content into a video stream that is delivered by video ecosystem 320 to user device 310.

In the performance of its duties, SSAI module 322 generates a manifest for each ad inserted into a video requested by a user device 310, which is provided by SSAI module 322 to the requesting user device 310, which in turn uses the manifest to assist in playback of the video with inserted targeted advertisements. Each manifest is a data structure, generated by SSAI module 322, that describes the structure of the video stream, including the timing and placement of ad insertions. Manifests are used by video player residing to play the video content and ads in the intended sequence. Manifests also ensure that the ads are displayed at the correct points during the video stream and that the transition between content and ads is smooth and unobtrusive. A single manifest may cover a single ad inserted into a video or may cover multiple ads that are shown sequentially.

Video ecosystem 320 and ADS 330 communicate with each other using a communication protocol known as Video Ad Serving Template (VAST), which facilitates the transfer of ad requests and responses between ADS 330 and SSAI module 322. When a user device 310 sends a request for video content to video ecosystem 320, SSAI module 322 is notified of the request; SSAI module 322 may, in turn, make a request (an ad request) to ADS 330 for one or more ads to insert into the video content requested by user device 310. ADS 330 processes such ad requests and responds by identifying the appropriate ad content, which is then communicated back to SSAI module 322 using the VAST protocol so that SSAI module 322 may insert the ad content into the video stream. The VAST protocol enables the dynamic selection and serving of ads in a manner that is compatible with various video players and ecosystems.

ADS 330, as broadly used herein, is an entity responsible for receiving and servicing individual ad requests from video ecosystem 220 using the VAST protocol. ADS 330 processes such ad requests and determines the appropriate ads to serve to the user device 230. ADS 330 may utilize various targeting criteria and algorithms to select ads that are relevant to the profile requesting the video content using user device 310. Once ADS 330 selects an ad for display to the user, ADS 330 communicates the ad content back to the SSAI module 322 for delivery to that user.

### Using Cohorts in a Server-Side Ad-Insertion Environment

Returning again to FIG. 1, after the performance of step 110, users of each CDN that video ecosystem 320 supports have been grouped into a plurality of cohorts. The number of cohorts will be substantially less than the number of users. As each member of a cohort will receive the same ads in the same requested video, the demands upon ADS 330 is lessened. Also, there are opportunities to cache content locally near requesting users so that the second and every subsequent member of a cohort may utilize cached content rather than retrieving all ad content from ADS 330.

In step 120, video ecosystem 320 receives a request from user device 310 to stream a live broadband video stream. For example, the user of user device 310 may request to view a live broadband video stream from a software application executing on their user device 310, which is then sent over a network for processing by video ecosystem 320.

In an embodiment, after receiving the request from user device 310 to stream a live broadband video stream, the cohort in which the user of user device 310 is a member is identified. As an example, a Cohort Identifier (ID), which is a unique identifier of a cohort, may be identified for the user of user device 310. In an embodiment, video ecosystem 320 identifies the cohort for the user issuing the request to stream a live broadband video stream. For example, SSAI module 322, or a software entity in communication therewith, may be tasked to identify the cohort for the user issuing the request to stream a live broadband video stream based on available information about the user of user device 310.

In another embodiment, video ecosystem 320 may identify an initial cohort for the user, and notify ADS 330 of that initial cohort identification. ADS 230, in turn, may have access to a different set of information about users, and may modify the cohort determination by assigning a higher priority cohort to the user based on the additional information available to ADS 330. ADS 330, upon making a different cohort determination than video ecosystem 320, would notify SSAI module 322 of the cohort identification along with all information pertaining to target ads for that cohort.

In yet another embodiment, video ecosystem 320 may provide to ADS 330 a first portion user characteristics without rendering an identification of a cohort. Upon receiving the user characteristic information for the user, ADS 3330 may then identify a particular cohort for the user requesting the live broadband video stream.

In step 130, after a particular cohort for the user requesting a live broadband video stream is identified, a particular advertisement to be shown to all members of that particular cohort watching the live broadband video stream is selected.

In certain embodiments, it may not be necessary for the video ecosystem 320 to communicate with ADS 330 to receive certain targeted ads for insertion into a requested video, as that information may already be cached in video ecosystem 320 as a result of processing a prior request associated with the same cohort.

Then, in step 140, the particular ad is incorporated into the live broadband video stream to create a cohort-targeted live video stream for the user. In an embodiment, SSAI 322 is responsible for incorporating ads into a video stream and generating a manifest for each inserted ad. Each manifest is a data structure, generated by SSAI module 322, that describes the structure of the video stream, including the timing and placement of ad insertions.

In step 150, video ecosystem 230 transmits the cohort-targeted live broadband video stream, and associated manifests created by SSAI module 322, to user device 110.

While FIG. 1 is presented in terms of a delivering a single targeted ad to a user, those in the art shall appreciate that certain steps of FIG. 1 may be repeated to accommodate displaying multiple ads sequentially in a single live broadband video stream.

### Tracking Viewership of an Ad

Advantageously, embodiments allow for ascertaining whether members of a cohort were presented with a targeted ad. To do so, embodiments rely upon the use of a Universal Resource Locator (URL) referred to herein as a beacon URL. FIG. 4 is an illustration of beacon URL generation and distribution in a server-side ad-insertion environment in accordance with an embodiment of the invention. Environment of FIG. 4 is similar to that shown in FIG. 3, but for an illustrative deployment location of Content Delivery Network (CDN) 480 and analytics module 490 within the environment shown in FIG. 4.

CDN 480 functions as a network of servers that work together to distribute content efficiently to users. The CDN of an embodiment is responsible for delivering the video content and ads from video ecosystem 420 to user device 410. By caching content at strategic locations, CDN 480 may reduce latency and improves the speed of content delivery, which is particularly important for maintaining the quality of experience during live events.

In an embodiment, CDN 480 is responsible for generating and distributing, to user device 410, a cohort-ID URL, which is a Universal Resource Locator (URL) that identifies the cohort, e.g., by identifying the Cohort ID. User device 410 uses the Cohort ID and information that uniquely identifies the user of user device 410 (i.e., a user identifier) to create a beacon URL. A beacon URL is used to track ad impressions and viewer engagement, by user device 410, for each user over the course of the presentation of targeted ads to that user. A beacon URL may be used by embodiments for collecting analytics data, which can be used to measure the effectiveness of ad campaigns and to further refine targeting strategies.

To illustrate, user device 410 may report to analytics module 490 what portion of a video has been watched by the user of user device 410 using a beacon URL repeatedly over the course of presenting a single targeted ad to the user. For example, at the beginning of an ad, user device 410 may report to analytics module 490 using the beacon URL that the beginning of an ad has been presented to the user, then after 25% of the targeted ad has been watched by that user, the user device 410 may report to analytics module 490 using that beacon URL that the first 25% of the targeted ad has been presented to the user of user device 410. This process may be repeated when 50% the targeted ad is watched by the user, when 75% the targeted ad is watched by the user, and then when the entirety of the targeted ad is watched by the user. Each time, when user device 410 reports to analytics module 490 using the beacon URL, analytics module 490 is made aware that a particular user has watched a particular portion of a particular targeted ad in a particular streaming video.

Analytics module 490 processes the data collected from the use of beacon URLs from a plurality of user devices. Analytics module 490 analyzes this data to provide insights into viewer behavior, ad performance, and engagement levels. Such information is valuable for advertisers and content providers as this analysis helps them understand the impact of their ad content and optimize their strategies for future campaigns.

Certain embodiments may randomly distribute the times at which beacon URLs are activated, smoothing out the processing load and preventing spikes in server demand, for example, if all viewers of a broadcast sent data to analytics module 490 at the same point in a live video broadcast, then analytics module 490 would receive a spike in incoming traffic at that time. This ensures that the system remains responsive and stable, even when dealing with millions of simultaneous viewers.

An embodiment of the audience tracking module might utilize a decentralized approach, where individual player tracking is achieved through a network of edge devices that process viewer interactions locally before sending aggregated data back to the server. This decentralized tracking can improve responsiveness and provide a more granular understanding of viewer engagement.

### Illustrative Embodiments

In one embodiment, high volumes of ad requests to ADS 430 from video ecosystem 420 may be handled during popular sports events by grouping viewers into cohorts based on shared characteristics, such as their favorite team or geographic location. This grouping allows the system to deliver the same ad to each viewer within a cohort, significantly reducing the number of individual ad transactions and enabling the use of cacheable manifests. The system's architecture is designed to integrate seamlessly with existing low-latency streaming workflows, ensuring that viewers experience minimal delay between the live action and the inserted ads.

In another embodiment supporting music concerts streamed online, cohorts may be formed based on the viewers' music genre preferences or past ticket purchases. Such an embodiment can employ sophisticated algorithms to predict which ads would be most relevant to each cohort, thereby enhancing viewer engagement and potential ad revenue. Embodiments may also dynamically adjust cohort sizes and characteristics in real-time based on viewer interactions and feedback.

In another embodiment that is tailored to support e-sports tournaments, cohort membership may be determined by the viewers' gaming interests, level of engagement with the e-sport, or even the type of device they are using to watch the event. Such an embodiment may be particularly adept at handling the rapid-fire ad requests typical of e-sports audiences, who are known for their high engagement and quick interactions. The embodiment may also feature advanced player tracking capabilities to provide detailed analytics on ad performance and viewer behavior.

In another embodiment that is tailored to support educational live streams, such as online courses or seminars, cohort membership may be based on the viewers' fields of study, academic institutions, or the specific courses in which they are interested. This embodiment would allow for highly targeted ad deliveries that align with the educational content, potentially increasing the relevance and effectiveness of the ads. This embodiment may ensure that ad delivery does not disrupt the educational experience, maintaining a balance between monetization and viewer satisfaction.

Each of these embodiments demonstrates the flexibility of DAI systems employing cohorts, showcasing the adaptability of the DAI system to various live event scenarios and audience segmentation strategies while maintaining the core functionality of efficient ad delivery and individual player tracking.

A further embodiment could include a transaction capping module that not only limits the number of VAST transactions issued from video ecosystem 420 to ADS 430 but also incorporates predictive analytics to anticipate the optimal number of cohorts needed for an event, thereby optimizing ad delivery and reducing unnecessary overhead. This module may also interface with real-time bidding systems to facilitate programmatic ad buying while maintaining the transaction cap.

### Implementing Mechanisms

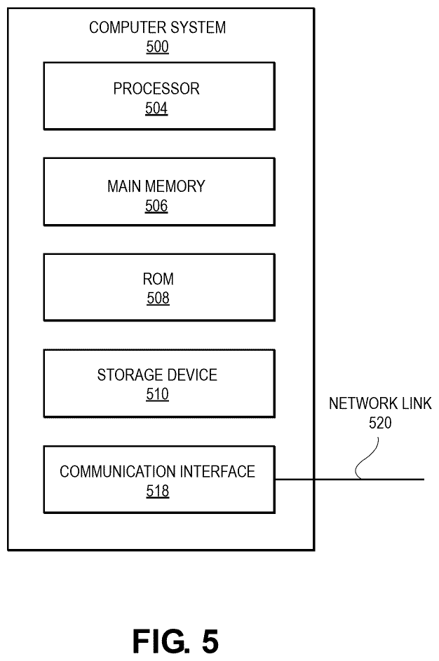

Embodiments of the invention are implemented upon a computer system, e.g., a user device, video ecosystem, ADS, CDN, and/or analytics module may be built, constructed, or implemented using one or more computer systems. The functions of certain entities, such as a video ecosystem and CDN for example, may be build using multiple computer systems arranged in a fault-tolerant manner. Indeed, each of the steps shown in FIG. 1 may be performed by a software application that executes upon a computer system. FIG. 5 is a block diagram of a computer system that may correspond to, in whole or in part, a component shown in FIGS. 3 and/or 4 in accordance with an embodiment of the invention. In an embodiment, computer system 500 includes processor 504, main memory 506, ROM 508, storage device 510, and communication interface 518. Computer system 500 includes at least one processor 504 for processing information. Computer system 500 also includes a main memory 506, such as a random-access memory (RAM) or other dynamic storage device, for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device for storing static information and instructions for processor 504. A storage device 510, such as a magnetic disk or optical disk, is provided for storing information and instructions.

Embodiments of the invention are related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “non-transitory computer-readable storage medium” as used herein refers to any tangible medium that participates in storing instructions which may be provided to processor 504 for execution. Non-limiting, illustrative examples of non-transitory machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of non-transitory computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a network link 520 to computer system 500.

Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through a local network to a host computer or to data equipment operated by an Internet Service Provider (ISP).

Computer system 500 can send messages and receive data, including program code, through the network(s), network link 520 and communication interface 518. For example, a server might transmit a requested code for an application program through the Internet, a local ISP, a local network, subsequently to communication interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. One or more non-transitory computer-readable storage mediums that store one or more sequences of instructions for server-side ad insertion (SSAI) systems operating on live broadband video streams, which when executed, cause:
grouping a plurality of users of a content delivery network (CDN) into a plurality of cohorts, wherein each cohort, of said plurality of cohorts, is a group of users which are associated with a matching set of user characteristics; and
upon a video ecosystem receiving a request to stream a live broadband video stream to a user, performing:
(a) identifying a particular cohort in which said user is a member,
(b) identifying a particular advertisement to be shown to all members of said particular cohort watching said live broadband video stream,
(c) incorporating said particular advertisement into said live broadband video stream to create a cohort-targeted live video stream for said first user, and
(d) transmitting, from said video ecosystem, said cohort-targeted live broadband video stream to a user device associated with said user.

2. The one or more non-transitory computer-readable storage mediums of claim 1, wherein said set of user characteristics conform to version 1.1 of an Interactive Advertising Bureau (IAB) taxonomy of user characteristics.

3. The one or more non-transitory computer-readable storage mediums of claim 1, wherein said set of user characteristics comprises at least three of following user characteristics: user wealth, user demographic, geographic location associated with a user account, user age, user income, a user interest, and user purchase intent.

4. The one or more non-transitory computer-readable storage mediums of claim 1, wherein at least a first portion of user characteristics for said user are identified by said video ecosystem and are provided, by said video ecosystem, to an Advertisement Decision System (ADS), wherein said ADS identifies, in consultation with said first portion of user characteristics provided by said video ecosystem, that said user is a member of said particular cohort.

5. The one or more non-transitory computer-readable storage mediums of claim 1, wherein said video ecosystem identifies that said user is a member of said particular cohort.

6. The one or more non-transitory computer-readable storage mediums of claim 1, wherein said user is a first user, and wherein execution of the one or more sequences of instructions further cause:
upon said video ecosystem receiving a second request to stream said live broadband video stream to a second user different from said first user, wherein said first user and said second user are both members of said particular cohort, performing:
(a) identifying said second user is a member of said particular cohort,
(b) consulting a cached manifest for said particular cohort to identify said particular advertisement to be shown to all members of said particular cohort watching said live broadband video stream, wherein said cached manifest is cached within said video ecosystem and is not retrieved, by issuing a Video Ad Serving Template (VAST) request to an Advertisement Decision System (ADS), after receiving said second request,
(c) incorporating said particular advertisement into said live broadband video stream to create a second cohort-targeted live video stream for said second user, and
(d) transmitting, from said video ecosystem, said second cohort-targeted live video stream to a second user device associated with said second user.

7. The one or more non-transitory computer-readable storage mediums of claim 1, wherein said cohort-targeted live broadband video stream comprises a unique identifier that identifies said particular cohort and said user.

8. A system for server-side ad insertion (SSAI) systems operating on live broadband video streams, comprising:
a software application, executing on one or more computer systems, grouping a plurality of users of a content delivery network (CDN) into a plurality of cohorts, wherein each cohort, of said plurality of cohorts, is a group of users which are associated with a matching set of user characteristics; and
upon a video ecosystem receiving a request to stream a live broadband video stream to a user, the video ecosystem performing:
(a) identifying a particular cohort in which said user is a member,
(b) identifying a particular advertisement to be shown to all members of said particular cohort watching said live broadband video stream,
(c) incorporating said particular advertisement into said live broadband video stream to create a cohort-targeted live video stream for said first user, and
(d) transmitting, from said video ecosystem, said cohort-targeted live broadband video stream to a user device associated with said user.

9. The system of claim 8, wherein said set of user characteristics conform to version 1.1 of an Interactive Advertising Bureau (IAB) taxonomy of user characteristics.

10. The system of claim 8, wherein said set of user characteristics comprises at least three of following user characteristics: user wealth, user demographic, geographic location associated with a user account, user age, user income, a user interest, and user purchase intent.

11. The system of claim 8, wherein at least a first portion of user characteristics for said user are identified by said video ecosystem and are provided, by said video ecosystem, to an Advertisement Decision System (ADS), wherein said ADS identifies, in consultation with said first portion of user characteristics provided by said video ecosystem, that said user is a member of said particular cohort.

12. The system of claim 8, wherein said video ecosystem identifies that said user is a member of said particular cohort.

13. The system of claim 8, wherein said user is a first user, and wherein said system further comprises:
said video ecosystem, upon receiving a second request to stream said live broadband video stream to a second user different from said first user, wherein said first user and said second user are both members of said particular cohort, performing:
(a) identifying said second user is a member of said particular cohort,
(b) consulting a cached manifest for said particular cohort to identify said particular advertisement to be shown to all members of said particular cohort watching said live broadband video stream, wherein said cached manifest is cached within said video ecosystem and is not retrieved, by issuing a Video Ad Serving Template (VAST) request to an Advertisement Decision System (ADS), after receiving said second request,
(c) incorporating said particular advertisement into said live broadband video stream to create a second cohort-targeted live video stream for said second user, and
(d) transmitting, from said video ecosystem, said second cohort-targeted live video stream to a second user device associated with said second user.

14. The one or more non-transitory computer-readable storage mediums of claim 1, wherein said cohort-targeted live broadband video stream comprises a unique identifier that identifies said particular cohort and said user.

15. A method for server-side ad insertion (SSAI) systems operating on live broadband video streams, comprising:
grouping a plurality of users of a content delivery network (CDN) into a plurality of cohorts, wherein each cohort, of said plurality of cohorts, is a group of users which are associated with a matching set of user characteristics; and
upon a video ecosystem receiving a request to stream a live broadband video stream to a user, performing:
(a) identifying a particular cohort in which said user is a member,
(b) identifying a particular advertisement to be shown to all members of said particular cohort watching said live broadband video stream,
(c) incorporating said particular advertisement into said live broadband video stream to create a cohort-targeted live video stream for said first user, and
(d) transmitting, from said video ecosystem, said cohort-targeted live broadband video stream to a user device associated with said user.

16. The method of claim 15, wherein said set of user characteristics conform to version 1.1 of an Interactive Advertising Bureau (IAB) taxonomy of user characteristics.

17. The method of claim 15, wherein said set of user characteristics comprises at least three of following user characteristics: user wealth, user demographic, geographic location associated with a user account, user age, user income, a user interest, and user purchase intent.

18. The method of claim 15, wherein at least a first portion of user characteristics for said user are identified by said video ecosystem and are provided, by said video ecosystem, to an Advertisement Decision System (ADS), wherein said ADS identifies, in consultation with said first portion of user characteristics provided by said video ecosystem, that said user is a member of said particular cohort.

19. The method of claim 15, wherein said video ecosystem identifies that said user is a member of said particular cohort.

20. The method of claim 15, wherein said user is a first user, and wherein execution of the one or more sequences of instructions further cause:
upon said video ecosystem receiving a second request to stream said live broadband video stream to a second user different from said first user, wherein said first user and said second user are both members of said particular cohort, performing:
(a) identifying said second user is a member of said particular cohort,
(b) consulting a cached manifest for said particular cohort to identify said particular advertisement to be shown to all members of said particular cohort watching said live broadband video stream, wherein said cached manifest is cached within said video ecosystem and is not retrieved, by issuing a Video Ad Serving Template (VAST) request to an Advertisement Decision System (ADS), after receiving said second request,
(c) incorporating said particular advertisement into said live broadband video stream to create a second cohort-targeted live video stream for said second user, and
(d) transmitting, from said video ecosystem, said second cohort-targeted live video stream to a second user device associated with said second user.

21. The method of claim 15, wherein said cohort-targeted live broadband video stream comprises a unique identifier that identifies said particular cohort and said user.
